(19) United States
(12) Patent Application Publication
(10) Pub. No.: US 2004/0107443 A1
(43) Pub. Date: Jun. 3, 2004

(54) Method and apparatus for proxy Pay-Per-View

(76) Inventor: Paul Andrew Clancy, Duluth, GA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/309,292

(22) Filed: Dec. 3, 2002

(51) Int. Cl. H04N 7/173

(52) U.S. Cl. 725/100; 725/87; 725/91

(57) ABSTRACT

The present invention provides a method for ordering a Pay-Per-View program by proxy. The method includes sending a program request from a first set top box (STB) to the head end unit requesting a program for a second STB, receiving the program request in the head end unit where the head end unit determines whether said first STB is authorized to make the program request for the second STB, and if the first STB is authorized to make the program request for the second STB, enabling the second STB to play the requested Pay-Per-View program.

### TECHNICAL FIELD

The present invention relates to the field of cable television services. More particularly, the present invention relates to a method for allowing a primary set-top box to purchase services by proxy for one or more other set-top boxes.

### BACKGROUND

Cable television was originally developed to improve signal reception to a number of end users living in remote areas. The earliest cable systems were, in effect, strategically placed antennas with very long cables connecting the antennas to subscribers' television sets. Cable television technology has now progressed to the use of coaxial and fiber optic cable networks with programming being broadcast from a system headend. In satellite television systems, the television signals are beamed directly from an orbiting satellite to a subscriber's dish antenna. In both cable and satellite systems, the subscriber typically employs a set-top box to interface his or her television set with the proprietary television system.

Along with the technological advancements came a number of programming options. One service that cable and satellite systems now frequently provide is Pay-Per-View (PPV) programming. Customers subscribing to a PPV program pay the cable or satellite television company an additional fee to watch special programming, for example, individual movies or sporting events.

Originally, PPV programs were transmitted to every end user as a scrambled analog signal. The program signal was scrambled by removing one of the multiple signals used to synchronize the television picture when the signal was transmitted. When a subscribing cable unit received the signal, the cable company would activate an addressable converter in the customer's set-top box. Once activated by the cable company, the addressable converter in the set-top box reinserted the removed signal. A subsequent signal scrambling method includes inserting a signal that was slightly offset from the channel's frequency in order to interfere with the picture. A subscribing cable unit would then be enabled through the addressable converter to filter the interfering signal out of the mix of signals received at the customer's television.

As digital systems have replaced analog, the method of providing PPV programming has also changed. Digital systems encrypt the PPV signal rather than scrambling the signal. The encrypted signal must be decoded using the proper key. A key is a specific code or value that enables a digital-to-analog converter to properly decode a digitally encrypted signal. Without the correct decoding key, the digital-to-analog converter cannot turn the stream of bits into anything usable by the television's tuner.

When a customer desired to view a PPV program, the customer traditionally called the cable company and, by speaking to an operator, ordered a specific program. After receiving the subscriber's billing information, the cable company would transmit the proper key to the customer's addressable converter, thereby enabling the digital-to-analog converter to properly decode the digitally encrypted PPV signal. While this method for enabling PPV programs is reliable, the method is also very expensive for cable companies. In order to handle the influx of PPV subscriptions and questions, cable companies are required to staff large operator centers.

With the recent incorporation of optical fibers between the cable head end transmitters and distribution nodes, both downstream and upstream signals are possible. The resulting systems are known as hybrid fiber-coaxial (HFC) systems. Upstream signal transmission was made possible through the use of duplex or two-way filters. These filters allow signals of certain frequencies to go in one direction and signals of other frequencies to go in the opposite direction. This upstream data transmission capability allowed cable companies to receive upstream PPV requests from set-top boxes with return path capabilities.

FIG. 1 illustrates the components of a prior art PPV assembly. As shown in FIG. 1, each set-top box (110) located in the house (100) of a subscriber is a return path set-top box (110) including a cable modem (120). The set-top boxes (110) are connected to the cable head end transmitter (140) by a co-axial or fiber optic cable network (130). Each set-top box (110) in the configuration of FIG. 1 was required have a cable modem (120) and upstream transmission capabilities in order to enable each set-top box (110) to communicate with the cable head end transmitter (140), and consequently allow each set-top box (110) to request a PPV program.

While the ability to send signals upstream reduced the operator requirements of the cable company, adding upstream transmission capabilities to a set-top box also greatly increases the price of the box. This increase in price may be restrictive to some cable subscribers, particularly those with multiple televisions and, consequently, multiple set-top boxes in the home.

### SUMMARY

In one of many possible embodiments, the present invention provides a method for ordering a PPV program by proxy. The method includes sending a program request from a first set top box (STB) to a head end unit requesting a program on behalf of a second STB, receiving the program request in the head end unit where the head end determines whether the first STB is authorized to make the program request for the second STB, and if the first STB is authorized to make the program request for the second STB, enabling the second STB to play the requested program.

Another embodiment of the present invention provides a cable system that allows proxy PPV requests. The system includes a lower-end (STB), a cable head end transmitter, and a return-path STB that includes firmware stored in a memory device which, when executed, allows a user to enter and transmit information regarding the lower-end STB, the return-path STB, and the ordered program to the cable head end transmitter. The cable system also includes a cable plant that communicatively connects the lower-end set top box and the return path set top box to the cable head end transmitter.

In an additional embodiment of the present invention, a STB for facilitating proxy program ordering is provided. The STB includes a modem, a microprocessor, and firmware stored in a memory device which, when executed, allows a user to enter and transmit information regarding the proxy program request.

### BRIEF DESCRIPTION OF THE DRAWINGS

The accompanying drawings illustrate various embodiments of the present invention and are a part of the specification. Together with the following description, drawings demonstrate and explain the principles of the present invention. The illustrated embodiments are examples of the present invention and do not limit the scope of the invention.

FIG. 1 illustrates a prior art PPV cable setup.

FIG. 2 is a block diagram illustrating a PPV cable setup according to one embodiment of the present invention.

FIG. 3 illustrates steps of performing a proxy PPV request according to one embodiment of the present invention.

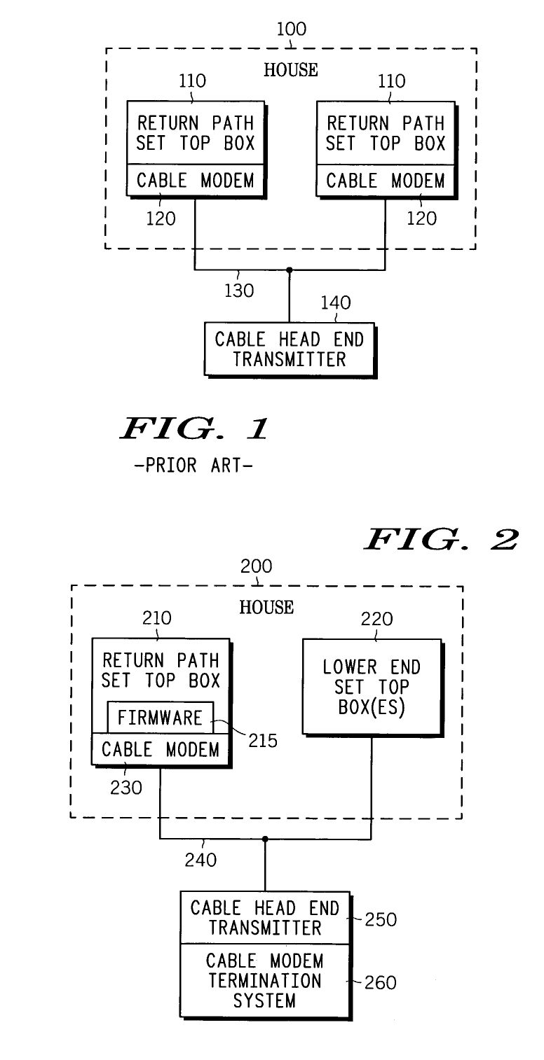

Throughout the drawings, identical reference numbers designate similar, but not necessarily identical, elements.

### DETAILED DESCRIPTION

A method and system are described herein for allowing a primary set-top box to order a PPV program by proxy for another set-top box. In the following description, for purposes of explanation, numerous specific details are set fort in order to provide a thorough understanding of the invention. It will be apparent, however, to one skilled in the art that the invention can be practiced without these specific details.

Reference in the specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment.

Exemplary Overall Structure

FIG. 2 illustrates a cable system according to one embodiment of the present invention. As shown in FIG. 2, multiple set-top boxes (STB) (210, 220) are located in a house or other subscriber location (200). One of the multiple set-top boxes is a return-path STB (210) including a modem (230). The return-path STB (210) has return path capabilities that enable the return-path STB (210) to send data upstream, through the cable plant (240), to a cable head end transmitter (250). A cable plant (240) is to be understood here and in the appended claims as any means of data transmission connecting STBs (210, 220) to a cable head end transmitter (250). The return-path STB (210) also contains firmware (215) which, when executed, presents the end user with a user interface that facilitates proxy PPV ordering. Also located within the subscriber location (200) and connected to the cable plant (240) is any number of lower-end STBs (220). The lower-end STBs (220) are STBs that do not include a modem or other means of transmitting data upstream to the head end transmitter (250).

The return-path STB (210) is equipped with a modem (230). A modem (230) is a device that enables a user to both transmit and receive digital information through a local cable plant (240). The modem (230) has two connections: one to a cable wall outlet in the subscriber location and the other to the return-path STB (210). A modem (230) performs modulation between analog and digital signals. The modem (230) may be either an external device, as shown, or an integrated device within the return-path STB (210). The modem (230) of the return-path STB (210) is preferably a cable modem and will be referred to hereafter as a cable modem. However, it is within the scope of the present invention to use any one of a telephone modem, a satellite modem, or any other device capable of modulating both analog and digital signals.

The return-path STB (210) is also equipped with firmware (215) that generates a user interface. The user interface is generated, for example, on the user's television when the firmware (215) is executed. The firmware (215) allows the user to enter information for controlling the return path set-top box (210) and ordering a PPV program for a lower-end set-top box (220) according to one embodiment of the present invention. The user interface may also be generated using components, such as a display and user input devices, which are incorporated into, connected to, or communicate wirelessly with the set-top box (210).

Alternatively, the present invention may incorporate application program interface (API) calls to enter the information required to perform one embodiment of the present invention. API calls are a specific method prescribed by a computer operating system or by an application program by which a programmer can make requests of an operating system or another application. In the present invention, API calls may provide an interface whereby a user may enter information to a return-path STB (210) used to make a proxy PPV request.

As shown in FIG. 2, any additional STB units located at the subscriber location are preferably lower-end STBs (220) that are also connected to the cable television system through the cable plant (240). The lower-end STBs (220) are capable of receiving incoming cable signals and, when the correct key is provided to an addressable converter (not shown), are able to unscramble or decrypt a secured PPV signal. However, the lower-end STBs (220) are not capable of sending information upstream to the cable head end (250) due to the lack of a cable modem (230). By using lower-end STBs (220), including the lowest cost set-top boxes, overall system price is reduced for the consumer.

The return-path STB (210) and the lower-end STBs (220) are connected to the cable head end transmitter (250) as shown in FIG. 2 by a cable plant (240). The cable plant (240) forming the connection between the STBs (210, 220) and the cable head end transmitter (250) may principally include a standard coaxial cable. Additionally, the STBs (210, 220) may be connected to the cable head end transmitter (250) using any number of signal transporting mediums, including but in no way limited to fiber optic cable, a combination of fiber optic cable and coaxial cable (HFC), telephone lines, or other wire and wireless communication mediums.

At the opposite end of the cable plant (240) from the STBs (210, 220) is the cable head end transmitter (250). The cable head end transmitter (250) is the electronic control center of a cable system, usually located near the antenna or microwave relay facilities (not shown), where incoming television signals are amplified, filtered, and converted, if necessary, before being delivered to the subscriber location (200). In distributing cable television services, the cable head end transmitter (250) typically includes a satellite dish antenna for receiving incoming programming from a satellite (not shown) or other signal transmitter. Additionally, when the cable head end transmitter (250) is connected to a return-path STB (210), the cable head end transmitter (250) is also capable of receiving and analyzing signals and data from the return-path STB (250).

A cable modem termination system (CMTS) (260) is located within the cable head end transmitter (250). The CMTS (260) is the component of the cable head end transmitter (250) that is able to communicate with the return-path STB (210) by sending and receiving signals. Much like an Ethernet connection, the CMTS (210) is capable of both selectively sending and receiving signals to and from all return-path STBs (210) connected to the cable system.

Exemplary Implementation and Operation

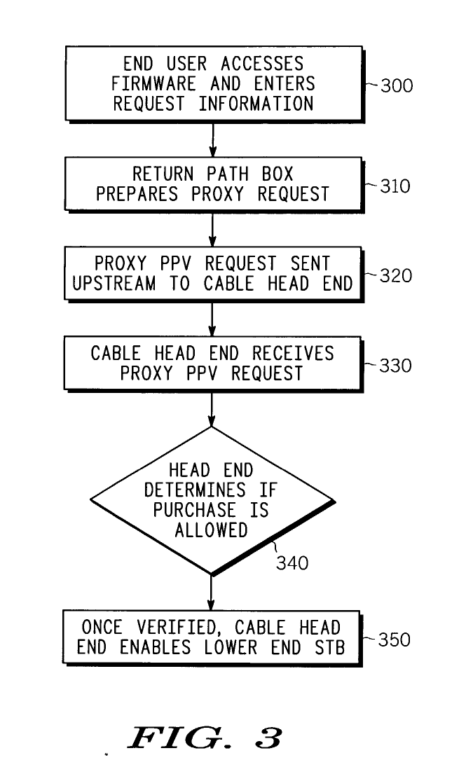

An embodiment of the present invention is initiated when an end user desires to subscribe to a PPV program and wishes to watch the PPV program on the television set to which the low-end STB (220) is connected. Because the low-end STB (220) has no means of signaling the head end transmitter (250) to purchase the PPV program, as illustrated in FIGS. 2 and 3, the end user accesses the user interface provided by the return-path STB (210) and enters the request information. Request information may include, for example, identification of the PPV program desired, identification of the set-top box that should receive and decode the PPV program, and authorization to place the order for the PPV program (step 300). Once the information is entered into the user interface, the return-path STB (210) prepares (step 310) and sends (step 320) a proxy request for the PPV program on behalf of the lower-end STB (220) upstream to the cable head end transmitter (250). When the cable head end transmitter (250) receives the proxy request (step 330), the cable head end transmitter (250) determines whether the proxy request is authorized (step 340). If the proxy request is authorized, the cable head end transmitter (250) enables the lower-end STB (220) to decode the desired PPV program (step 350).

As shown in FIG. 3, the present invention begins when the end user accesses the firmware (215, FIG. 2) contained within the return-path STB (210, FIG. 2) and enters proxy request information (step 300). The firmware may be accessed in a number of different ways. In a preferred embodiment, the return-path STB (210, FIG. 2) contains a microprocessor (not shown) that is able to receive data signals from a wireless keyboard, a mouse or other user input device. The keyboard is used to enter the proxy request information. Alternatively, a remote control, a webpad, or any other device capable of entering proxy information to the user interface may access the firmware. Once accessed, the firmware generates a user interface that prompts the user for proxy request information. The proxy request information includes at least the program being requested, an identifier that indicates the return-path STB (210, FIG. 2) sending the proxy request, and an identifier that indicates which lower-end STB (220, FIG. 2) the proxy request is being made for. The identifier may be a unit number, a descriptive name, or any other identifier that can be used to distinguish one STB from the other STBs connected to the cable system.

When the proxy request information has been entered into the user interface, the return-path STB (210, FIG. 2) prepares a message to be sent upstream to the cable head end transmitter (step 310). The message provided by the return-path STB (210, FIG. 2) contains a field identifying both the return-path STB (210, FIG. 2) sending the message to the cable head end transmitter (250, FIG. 2) and identifying the lower-end STB (220, FIG. 2) for which the proxy request is being made. The message is preferably header information containing a logical name that identifies each unit or an actual unit address. In addition to the unit information, the message prepared by the return-path STB (210, FIG. 2) also includes information indicating the program being requested.

Once the message is prepared by the microprocessor of the STB (210, FIG. 2), the message data is sent upstream through the cable plant (240, FIG. 2) to the cable head end unit (step 320). A modulator (not shown), sometimes called a burst modulator, located within the cable modem (230, FIG. 2) is used to convert the digital computer network data into radio-frequency signals for transmission through a coaxial cable plant (240, FIG. 2). In an alternative embodiment, a fiber optic cable, a hybrid fiber optic cable-coaxial cable, or a telephone line is used to transmit digital signals from the return-path STB (210, FIG. 2) to the cable head end transmitter (250, FIG. 2).

As shown in FIG. 3, when the proxy PPV request is sent over the cable plant (240, FIG. 2), the cable head end transmitter (250, FIG. 2) receives the request (step 330). Once received, the cable head end transmitter (250, FIG. 2) parses the received information and verifies that the proxy PPV purchase is allowed (step 340). The cable head end (250, FIG. 2) verifies that the proxy PPV purchase is allowed (step 34) by identifying both the requesting return-path STB (210, FIG. 2) and the lower-end STB (220, FIG. 2) for which the request is being made. The cable head end (250, FIG. 2) also verifies that both the return-path STB (210, FIG. 2) and the lower-end STB (220, FIG. 2) belong to the same customer. The verification is performed by comparing the identified STBs to PPV subscriber lists. If subscriber lists confirm that both STBs are ascribed to the same subscriber, the cable head end transmitter (250, FIG. 2) authorizes the PPV purchase.

Once the STBs are verified, the cable head end (250, FIG. 2) enables the purchase of the PPV program by sending messages through the cable plant (240, FIG. 2) addressed to the lower-end STB (220, FIG. 2) for which the request was made (step 350). The messages are sent by the CMTS (260, FIG. 2) of the cable head end transmitter (250, FIG. 2). The CMTS (260, FIG. 2) selectively transmits a signal to the addressed lower-end STB (220, FIG. 2) thereby enabling the “addressable converter” of the lower-end STB (220, FIG. 2). Once enabled, the addressable converter de-scrambles or decodes the ordered PPV program signal for the duration of the program ordered. All PPV “buys” are then totaled by computer and added to the cable subscriber's monthly bill.

It is also within the scope of the present invention to apply the teachings of the present invention to a satellite receiver box. According to this embodiment, a single satellite receiver box with return path capabilities may be used to perform a proxy PPV request for a lower-end satellite receiver box that does not have return path capabilities.

Alternative Embodiment

In an alternative embodiment, the method and system described herein are applied to a video-on-demand (VOD) system. VOD is an interactive system that allows addressable subscribers to order PPV movies at start times determined by the subscribers themselves. An array of movies or other programming is digitally stored, preferably on a file server located at the cable head end transmitter (250, FIG. 2). The server will transmit a selected movie or program from this library to a specific subscriber who has ordered that program. The server will commence the transmission at any time that a program is ordered or at some other user-specified time, thereby allowing the subscriber to determine when the transmission of the ordered program is to begin. Once the digital file is received at the subscriber's STB (e.g., 220, FIG. 2), the program is either converted from digital to analog for viewing on analog-based television receivers or kept in their digital format for digital television receivers.

According to this alternative embodiment, a return-path STB (210, FIG. 2) makes a proxy request on behalf of a lower-end STB (220, FIG. 2) as described above. However, the user interface of the alternative embodiment may contain additional fields when compared to the embodiment mentioned above. In order to perform proxy ordering for VOD, the user interface of the alternative embodiment may additionally request information regarding the user's desired start time of the VOD program. Alternatively, the VOD order may simply use the time the order is placed as the time the VOD program is to be transmitted.

Once all the request information is entered into the user interface, the return-path STB (210, FIG. 2) sends the information over the cable plant (240, FIG. 2) to the cable head end (250, FIG. 2). When the cable head end transmitter (250, FIG. 2) receives the information, the cable head end (250, FIG. 2) confirms that the requesting return-path STB (210, FIG. 2) is authorized to make the request for the lower-end STB (220, FIG. 2). If authorized, the cable head end unit (250, FIG. 2) transmits the requested program to the indicated lower-end STB (220, FIG. 2) at the requested time.

In conclusion, the present invention, in its various embodiments, allows for the use of a single return-path STB to request PPV programs for one or more lower-end STBs. Specifically, the present invention allows one return-path STB to make a program request by proxy to the cable head end transmitter on behalf of a lower-end STB that does not have return path capabilities. By allowing for the use of one return-path STB to request programs for a number of less technologically sophisticated STBs, the system cost for an end user is greatly reduced. The present invention also reduces the complexity and cost to an end user by eliminating the need for communication lines between the return-path STB and the lower-end STBs. Moreover, the present invention reduces the operation costs to cable operators by making it unnecessary to employ a large number of operators in a call center.

The preceding description has been presented only to illustrate and describe the invention. It is not intended to be exhaustive or to limit the invention to any precise form disclosed. Many modifications and variations are possible in light of the above teaching. It is intended that the scope of the invention be defined by the following claims.

What is claimed is:

1. A method for ordering a program by proxy comprising:
sending a program request from a first set top box (STB) to a head end unit requesting a program for a second STB.

2. The method of claim 1, further comprising:
receiving said program request in said head end unit;
determining whether said first STB is authorized to make said program request for said second STB; and
if said first STB is authorized to make said program request for said second STB, enabling said second STB to play said requested program.

3. The method of claim 1, wherein said step of sending a program request from said first STB to said head end unit requesting a program for a second STB comprises:
accessing firmware in said first STB;
generating a user interface based on said firmware;
entering information requested by said user interface to identify said second STB and said requested program;
packaging said information for transmission; and
sending said packaged information to said head end unit.

4. The method of claim 1, wherein said program comprises a Pay-Per-View (PPV) program.

5. The method of claim 1, wherein said program request from said first STB to said head end unit is transmitted over a cable plant.

6. The method of claim 5, wherein said cable plant comprises a coaxial cable.

7. The method of claim 5, wherein said cable plant comprises a fiber optic cable.

8. The method of claim 5, wherein said cable plant comprises a hybrid fiber-coaxial system.

9. The method of claim 5, wherein said cable plant comprises a telephone line.

10. The method of claim 2, wherein said step of determining whether said first STB is authorized to make said program request for said second STB comprises:
parsing said STB identifying information from said packaged information; and
comparing said STB identifying information to a subscribing user list.

11. The method of claim 2 wherein said enabling of said second STB to play said requested program comprises sending a decoding key from said head end unit to said second STB thereby enabling said second STB to decode said requested program.

12. The method of claim 1, wherein said requested program comprises a video-on-demand program.

13. The method of claim 1, wherein the step of sending a program request from a first STB to said head end unit requesting a program for a second STB comprises using API calls to provide an interface for entering request information to said first STB.

14. A method for ordering a program by proxy comprising:
sending a program request from a first STB to a head end unit requesting a program for a second STB including accessing firmware in said first STB, generating a user interface based on said firmware, entering information requested by said user interface to identify said second STB and said requested program, packaging said information for transmission, and sending said packaged information to said head end unit;
receiving said program request in said head end unit;
determining whether said first STB is authorized to make said program request for said second STB including parsing said STB identifying information from said packaged information, and comparing said STB identifying information to a subscribing user list; and
if said first STB is authorized to make said program request for said second STB, enabling said second STB to play said requested program.

15. The method of claim 14, wherein said program comprises a PPV program.

16. The method of claim 15, wherein said step of enabling said second STB to play said requested program comprises sending a decoding key from said head end unit to said second STB thereby enabling said second STB to decode said requested program.

17. The method of claim 16, wherein said step of entering information requested by said firmware to identify said second STB and said requested program comprises transmitting said information to said first STB using a wireless keyboard.

18. The method of claim 14, wherein said program comprises a video-on-demand program.

19. The method of claim 18, wherein said step of entering information requested by said user interface further comprises identifying desired start time of said video-on-demand program.

20. A cable system for ordering a program by proxy comprising:
a lower-end STB;
a cable head end transmitter;
a return-path STB including firmware stored in memory device which, when executed, generates a user interface that allows a user to enter and transmit information regarding said lower-end STB, said return-path STB, and an ordered program for receipt by said lower-end STB to said cable head end transmitter; and
a cable plant communicatively coupling said lower-end set top box and said return path set top box to said cable head end transmitter.

21. The system of claim 20, wherein said return path set top box further comprises:
an addressable converter capable of selectively receiving addressed signals from said cable head end transmitter; and
a cable modem.

22. The system of claim 20, wherein said lower-end STB comprises an addressable converter capable of selectively receiving addressed signals from said cable head end transmitter.

23. The system of claim 22, wherein said cable head end transmitter comprises a cable modem termination system capable of communication with said return-path STB.

24. The system of claim 23, wherein said cable plant comprises a coaxial cable.

25. The system of claim 23, wherein said cable plant comprises a fiber optic cable.

26. The system of claim 23, wherein said cable plant comprises a hybrid fiber coaxial system.

27. The system of claim 21, wherein said program comprises a PPV program.

28. The system of claim 21, wherein said program comprises a video-on-demand program.

29. A system for ordering a program by proxy comprising:
a lower-end STB including an addressable converter capable of selectively receiving addressed signals from said cable head end transmitter;
a cable head end transmitter including a cable modem termination system;
a return-path STB including an addressable converter capable of selectively receiving addressed signals from said cable head end transmitter, a cable modem, and firmware stored in a memory device which, when executed, generates a user interface that allows a user to enter and transmit program request information on behalf of said lower-end STB from said return-path STB to said cable head end transmitter; and
a cable plant communicatively coupling said lower-end set top box and said return path set top box to said cable head end transmitter.

30. The system of claim 29, wherein said program comprises a PPV program.

31. The system of claim 29, wherein said program comprises a video-on-demand program.

32. An apparatus for facilitating proxy program ordering comprising a return path set-top box including a modem, a microprocessor, and firmware stored in a memory device which, when executed, allows a user to enter and transmit information regarding said proxy program request on behalf of another set-top box.

33. An apparatus according to claim 32, wherein said firmware, when executed, generates a user interface to facilitate said entering of information regarding said proxy program request.

34. An apparatus according to claim 33, wherein said information regarding said proxy program request comprises identifiers to identify said return path set-top box making said proxy request, a set-top box to receive a requested program, and the program being requested.

35. An apparatus according to claim 34, wherein said return path set-top box further comprises a set-top box.

36. An apparatus according to claim 34, wherein said return path set-top box further comprises a satellite receiver box with return path capabilities.

37. An apparatus according to claim 32, wherein said firmware, when executed, generates application program interface calls to facilitate said entering of said program request information.

38. A system for ordering a program by proxy comprising:
a first signal receiving means for receiving television program signals;
a signal transmitting means for transmitting program signals;
a second signal receiving means capable of both transmitting and receiving signals, wherein said second signal receiving means includes firmware stored in a memory device which, when executed, generates a user interface that facilitates a user to both enter and transmit program request information from said second signal receiving means on behalf of said first signal receiving means to said signal transmitting means; and
a communications means for communicatively coupling said first signal receiving means and said second signal receiving means to said signal transmitting means.

39. The system of to claim 38, wherein said first signal receiving means comprises a lower-end STB.

40. The system of to claim 38, wherein said second signal receiving means comprises a return-path STB.

41. The system of to claim 38, wherein said signal transmitting means comprises a cable head end transmitter.

42. An apparatus for facilitating proxy program ordering comprising:
a communications means for both receiving and transmitting signals;
a processing means for processing said transmitted signals; and
firmware stored in a memory device which when executed generates a user interface that allows a user to enter and initiate transmission of information regarding a proxy program request made on behalf of a separate communications device.

43. The apparatus of claim 42, wherein said communications means comprises a cable modem.

44. The apparatus of claim 42, wherein said processing means comprises a microprocessor.
